(19) United States
(12) Patent Application Publication
(10) Pub. No.: US 2022/0126853 A1
(43) Pub. Date: Apr. 28, 2022

(54) METHODS AND SYSTEMS FOR STICHING OF IMAGES INTO A VIRTUAL IMAGE

(71) Applicant: GM GLOBAL TECHNOLOGY OPERATIONS LLC, Detroit, MI (US)

(72) Inventors: Mohannad Murad, Troy, MI (US); Fred W. Huntzicker, Ann Arbor, MI (US); Lior Stein, Ramat Hasharon (IL); Sai Vishnu Aluru, Commerce, MI (US); Alexander Sherman, Petah Tikva (IL); Yahav Zamari, Atlit (IL)

(73) Assignee: GM GLOBAL TECHNOLOGY OPERATIONS LLC, Detroit, MI (US)

(21) Appl. No.: 17/079,966

(22) Filed: Oct. 26, 2020

(51) Int. Cl. B60W 50/14; B60R 1/00; G06T 5/00; G06T 5/50

(52) U.S. Cl. CPC B60W 50/14; B60R 1/00; B60R 2001/1253; G06T 5/50; B60W 2050/146; G06T 5/002

(57) ABSTRACT

A system and method are provided for aiding an operator in operating a vehicle. In one embodiment, a system includes a sensor system configured to generate sensor data sensed from an environment of the vehicle. The system further includes a control module configured to, by a processor, determine a scene of the environment based on the sensor data, memorize a shape of at least one feature in the scene, modify video data based on the memorized shape, and present the modified video data for display to the operator.

### TECHNICAL FIELD

This technical field generally relates to operator aid systems for vehicles, and more particularly, relates to methods and systems for providing a virtual image of under vehicle environments.

Vehicles may incorporate and utilize numerous aids to assist the operator. For example, various sensors may be disposed at various locations of the vehicle. The various sensors sense observable conditions of the environment of the vehicle. For example, a plurality of cameras or other sensors may sense a condition of the road or environment that the vehicle is traveling or about to travel. In some instances, it is desirable to present to an operator an under-hood view or virtual view of the images. In such instances, the images provided by the various cameras must be stitched together to create the virtual view.

Accordingly, it is desirable to provide methods and systems for improved stitching of a plurality of images into a single a virtual image. Other desirable features and characteristics of the herein described embodiments will become apparent from the subsequent detailed description and the appended claims, taken in conjunction with the accompanying drawings and the foregoing technical field and background.

### SUMMARY

In one exemplary embodiment, a system and method are provided for aiding an operator in operating a vehicle. In one embodiment, a system includes a sensor system configured to generate sensor data sensed from an environment of the vehicle. The system further includes a control module configured to, by a processor, determine a scene of the environment based on the sensor data, memorize a shape of at least one feature in the scene, modify video data based on the memorized shape, and present the modified video data for display to the operator.

In various embodiments, the sensor system includes one or more cameras.

In various embodiments, the at least one feature includes a printed marking on the ground.

In various embodiments, the control module is further configured to, by the processor, stitch the sensor data to form the scene of the environment, and identify an error in a feature of the stitched sensor data, and wherein the video data is modified based on the identified error. In various embodiments, the control module is further configured to match the feature having the error to the memorized shape.

In various embodiments, the control module is configured to, by the processor, modify the video data by warping the ground plane of one or more parts of stitched scene data based on the memorized shape.

In various embodiments, the control module is configured to modify the video data by smoothing lines in the warped ground plane. In various embodiments, the control module is further configured to modify the video data by sharpening an edge of the smoothed lines in the warped ground plane. In various embodiments, the control module is further configured to stitch the sensor data and the memorized shape to modify the video data.

In various embodiments, the control module is configured to compute a confidence score based on at least one of vehicle speed data, steering angle data, and real-world geometry data, and modify the video data by stitching the video data based on the memorized shape and the confidence score.

In another embodiment, a method includes: receiving sensor data from a sensor system that senses an environment of the vehicle; determining, by a processor, a scene of the environment based on the sensor data; determining, by the processor, a shape of a feature in the environment based on the sensor data; modifying, by the processor, video data based on the shape of the feature in the environment; and generating display data to display the modified video data for viewing by the operator of the vehicle.

In various embodiments, the sensor system includes one or more cameras.

In various embodiments, the at least one feature includes a marking on a ground plane.

In various embodiments, method further includes stitching the sensor data to form the scene of the environment and identifying an error in a feature of the stitched sensor data, and wherein the video data is modified based on the identified error. In various embodiments, method further includes matching the feature having the error to the memorized shape.

In various embodiments, the method further includes modifying the video data by warping the ground plane of one or more parts of stitched scene data based on the memorized shape. In various embodiments, the method further includes modifying the video data by smoothing lines in the warped ground plane. In various embodiments, the method further includes modifying the video data by sharpening an edge of the smoothed lines in the warped ground plane. In various embodiments, the method further includes stitching the sensor data and the memorized shape to modify the video data.

In various embodiments, the method further includes computing a confidence score based on at least one of vehicle speed data, steering angle data, and real-world geometry data, and wherein the method modifies the video data by stitching the video data based on the memorized shape and the confidence score

### DESCRIPTION OF THE DRAWINGS

The exemplary embodiments will hereinafter be described in conjunction with the following drawing figures, wherein like numerals denote like elements, and wherein:

FIG. 1 is an illustration of a top perspective schematic view of a vehicle having a virtual reality system in accordance with various embodiments;

FIG. 2 is a functional block diagram illustrating a virtual reality system in accordance with various embodiments;

FIG. 3 is an illustration of a display of the virtual reality system in accordance with various embodiments;

FIG. 4 is a dataflow diagram illustrating the control module of the virtual reality system in accordance with various embodiments; and

FIGS. 5 and 6 are flowcharts illustrating methods of controlling content to be displayed on a display screen of the virtual reality system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that contains one or more executable software or firmware programs and associated data, a combinational logic circuit, and/or other suitable components that provide the described functionality.

Embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components, e.g., towing apparatus, indicators or telltales; and electrical components, e.g., integrated circuit components, memory elements, digital signal processing elements, logic elements, look-up tables, imaging systems and devices or the like, which may carry out a variety of functions under the control of one or more microprocessors or other control devices. In addition, those skilled in the art will appreciate that the herein described embodiments may be practiced in conjunction with any number of mechanical and/or electronic systems, and that the vehicle systems described herein are merely exemplary.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

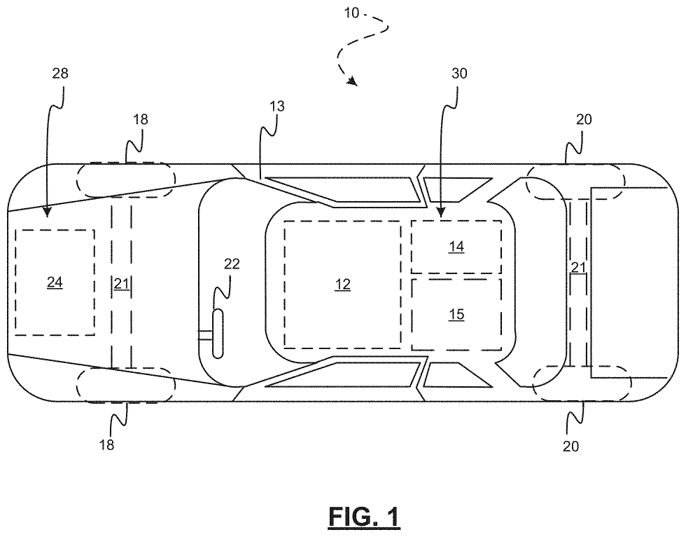

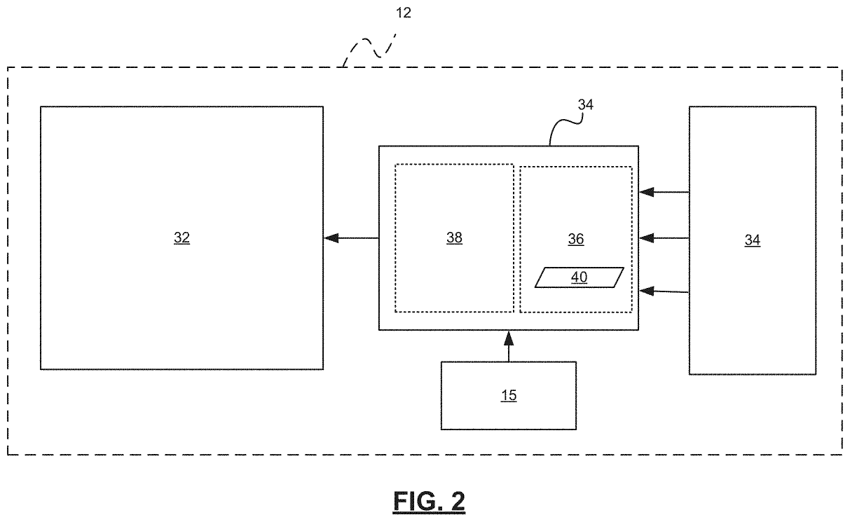

FIG. 1 is an illustration of a top view of a vehicle shown generally at 10 equipped with a virtual reality system shown generally at 12 in accordance with various embodiments. As will be discussed in more detail below, the virtual reality system 12 generally uses data from a sensor system 14 of the vehicle 10 along with customizable software to allow a user to experience a virtual reality of a feature underneath the vehicle 10. As used herein, the term “virtual reality” refers to a replication of an environment and/or component, real or imagined. For example, the virtual reality system 12 can be implemented to provide a visualization of features underneath the vehicle 10. In such examples, a display screen 16 (FIG. 2) can be placed in any location of the vehicle 10 and can display images and/or videos that create a virtual reality of the underneath of the vehicle 10, for example, as if the vehicle hood or the vehicle under carriage were invisible.

Although the context of the discussion herein is with respect to the vehicle 10 being a passenger car, it should be understood that the teachings herein are compatible with all types of automobiles including, but not limited to, sedans, coupes, sport utility vehicles, pickup trucks, minivans, full-size vans, trucks, and buses as well as any type of towed vehicle such as a trailer.

As shown in the example of FIG. 1, the vehicle 10 generally includes a body 13, front wheels 18, rear wheels 20, a suspension system 21, a steering system 22, and a propulsion system 24. The wheels 18-20 are each rotationally coupled to the vehicle 10 near a respective corner of the body 13. The wheels 18-20 are coupled to the body 13 via the suspension system 21. The wheels 18 and/or 20 are driven by the propulsion system 24. The wheels 18 are steerable by the steering system 22.

The body 13 is arranged on or integrated with a chassis (not shown) and substantially encloses the components of the vehicle 10. The body 13 is configured to separate a powertrain compartment 28 (that includes at least the propulsion system 24) from a passenger compartment 30 that includes, among other features, seating (not shown) for one or more occupants of the vehicle 10. As used herein, the components “underneath” the vehicle 10 are components disposed below the body 13, such as, but not limited to, the wheels 18 and 20 (including their respective tires), and the suspension system 21.

The vehicle 10 further includes a sensor system 14 and an operator selection device 15. The sensor system 14 includes one or more sensing devices that sense observable conditions of components of the vehicle 10 and/or that sense observable conditions of the exterior environment of the vehicle 10. The sensing devices can include, but are not limited to, radars, lidars, global positioning systems, optical cameras, thermal cameras, ultrasonic sensors, height sensors, pressure sensors, steering angle sensors, and/or other sensors. The operator selection device 15 includes one or more user manipulable devices that can be manipulated by a user in order to provide input. The input can relate to, for example, activation of the display of virtual reality content and a desired viewing angle of the content to be displayed. The operator selection device 15 can include a knob, a switch, a touch screen, a voice recognition module, etc.

As shown in more detail in FIG. 2 and with continued reference to FIG. 1, the virtual reality system 12 includes a display screen 32 communicatively coupled to a control module 34. The control module 34 is communicatively coupled to the sensor system 14 and the operator selection device 15.

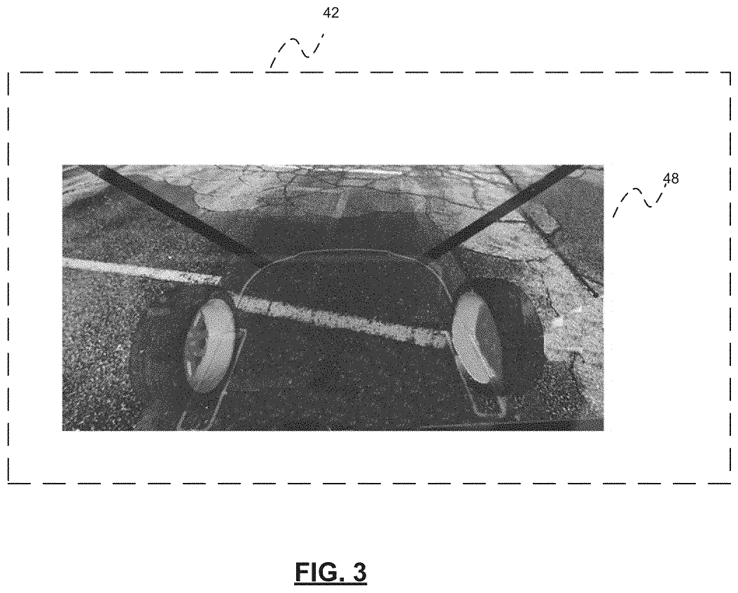

The display screen 32 may be disposed within the passenger compartment 30 at a location that enables viewing by an operator of the vehicle 10. For example, the display screen 32 may integrated with an infotainment system (not shown) or instrument panel (not shown) of the vehicle 10. The display screen 32 displays content such that a virtual reality is experienced by the viewer. For example, as shown in FIG. 3, in various embodiments, the content 42 includes graphics of vehicle components, graphics of terrain features and a depiction of a scene 48 the vehicle 10 is traveling, including the ground, curbs, road markings, buildings, etc.

The virtual reality content 42 can be displayed in realtime and/or can be predefined. For example, as shown in FIG. 3, a scene of the environment is produced by stitching together sensor data from one or more sensors. Thereafter, a virtual image of the front tires is super imposed on the scene of the environment to create a virtual image depicting under the hood and revealing the terrain. The stitched scene and/or the virtual image is presented in an improved manner based on extracted features from live scenes. For example, as will be discussed in more detail below, shapes of features are extracted from live scenes and memorized. When the scene is stitched, the stitching is improved by using the memorized features. The final stitched image is then presented to the operator in a manner that maintains the memorized shapes of the features.

With reference back to FIG. 1, the control module 34 may be dedicated to the display screen 32, may control the display screen 32 and other features of the vehicle 10 (e.g., a body control module, an instrument control module, or other feature control module), and/or may be implemented as a combination of control modules that control the display screen 32 and other features of the vehicle 10. For exemplary purposes, the control module 34 will be discussed and illustrated as a single control module that is dedicated to the display screen 32. The control module 34 controls the display screen 32 directly and/or communicates data to the display screen 32 such that virtual reality content can be displayed.

The control module 34 includes at least memory 36 and a processor 38. As will be discussed in more detail below, the control module 34 includes instructions that when processed by the processor 38 control the content to be displayed on the display screen 32 based on sensor data received from the sensor system 14 and user input received from the operator selection device 15. The control module further includes instructions that when processed by the processor 38 control the content to be displayed based on the memorized shapes of the features and videos as will be described in more detail below.

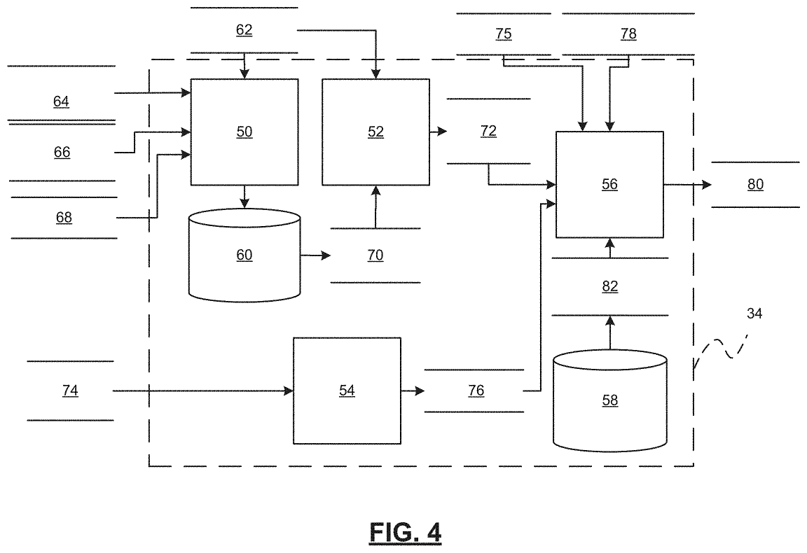

Referring now to FIG. 4 and with continued reference to FIG. 1-3, a dataflow diagram illustrates various embodiments of the control module 34 in greater detail. Various embodiments of the control module 34 according to the present disclosure may include any number of sub-modules. As can be appreciated, the sub-modules shown in FIG. 4 may be combined and/or further partitioned to similarly generate virtual reality content to be viewed by an operator. Inputs to the control module 34 may be received from the sensor system 14, received from the operator selection device 15, received from other control modules (not shown) of the vehicle 10, and/or determined by other sub-modules (not shown) of the control module 34.

In various embodiments, the control module 34 includes a shape determination module 50, a stitching module 52, a vehicle component determination module 54, a display determination module 56, a graphics datastore 58, and a feature datastore 60.

The graphics datastore 58 receives and stores graphics for various features of the vehicle 10 such as features underneath the vehicle 10 including the front tires 18, the rear tires 20, the suspension system components, etc. as shown, for example, in FIG. 3. The feature datastore 60 receives and stores shape data for various features of scenes in an environment of the vehicle 10 as determined by the shape determination module 50.

The shape determination module 50 receives as input sensor data 62. The shape determination module 50 extracts a frame depicting a scene of the environment from the sensor data 62. The shape determination module 50 identifies key features such as key points or lines of shapes (e.g., markings on the road such as a line, multiple lines, dashed lines, intersection of lines, straight lines, curved lines, circles, etc.) from the scene in the frame. The shape determination module 50 computes a confidence score of the identified shape data. For example, the shape determination module 50 computes one or more confidence scores based on current steering wheel data 64, vehicle speed data 66, and real-world geometry data 68. The shape determination module 50 then uses the confidence scores to compute weights to be associated with models used in the stitching (e.g., geometric model, feature fitting model, etc.) based. For example, as the parameters (e.g., steering wheel data 64, vehicle speed data 66, and real-world geometry data 68) increase, the weights associated with one of the models (e.g., the geometric model) are reduced while the weights associated with another model (e.g., the feature fitting model) is increased. The shape determination module 50 then computes coordinates of the shape relative to the vehicle (e.g., in a vehicle coordinate system) based on the confidence score and the weights and stores the shape data in the feature datastore 60.

The stitching module 52 receives as input the sensor data 62. The stitching module 52 produces scenes of the environment based on the sensor data 62. For example, the sensor data 62 can include image data or video data provided by a plurality of cameras disposed around the vehicle 10, and the stitching module 52 stitches the data 62 to produce a scene (e.g., 360-degree view, or other view of the environment). The stitching module 52 stitches the scene with memorized images of vehicle components.

Thereafter, the stitching module 52 processes the stitched scene to determine the content. When stitching errors are found (e.g., lines are broken or skewed), the stitching module 52 adjusts the stitched image of the scene based on the shape data 70 stored in the feature datastore 60.

For example, the stitching module 52 processes the scene image to remove any shadows from the scene and then matches features from the stitched image of the scene with features identified by the shape data 70 stored in the feature datastore 60. The stitching module 52 adjusts the stitching between the memorized data and the live image of the scene to maintain the matched shape data 70 using the weights and one or more models as discussed above. For example, the stitching module 52 adjusts parts of the memorized data and applies shifting to the different memorized parts in the stitched image to maintain the shape and the coordinates of the shape data 70 to produce a blended transparent area; and then smooths joint areas between the live and memorized data using a filter such as, but not limited to, a harmonic mean filter. Optionally, the stitching module sharpens the inside edges of any contours. The stitching module then produces the finalized stitched scene as scene data 72.

The vehicle component determination module 54 receives as input sensor data 74. The vehicle component determination module 54 processes the sensor data 74 to determine an actual position of the various vehicle features. For example, the sensor data 74 can include height data, pressure data, etc. from the body 13 and/or suspension system 21. The vehicle component determination module 54 generates vehicle data 76 based on the actual position of the vehicle features.

The display determination module 56 receives as input the scene data 72, the vehicle data 76, and user input data 78. Based on the received data, the display determination module 56 generates display data 80 to display the content 42 including the improved scene and the vehicle features as a virtual reality to an operator.

For example, as the vehicle 10 travels, the display determination module 56 embeds graphics 82 retrieved from the graphics datastore 58 illustrating the under vehicle features in the scene based on the current location. The display determination module 56 retrieves the graphics 82 of the vehicle features from the graphics datastore 58 based on the selected viewing angle indicated by the user input data 78. The display determination module 56 then overlays the altered vehicle feature graphics on the scene indicated by the scene data 72. The display determination module 56 then generates the display data 80 that includes the scene, and the vehicle component graphics.

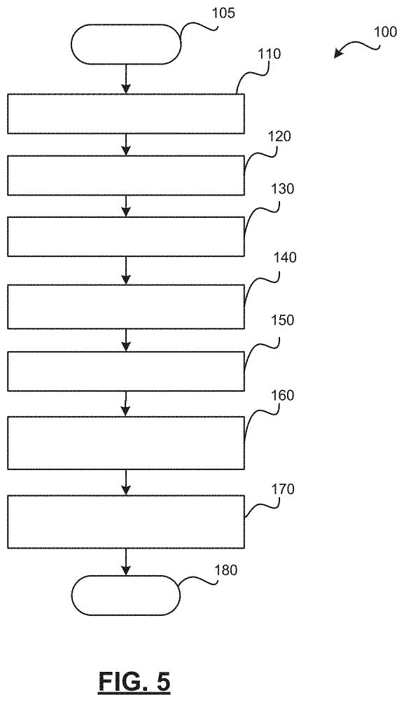

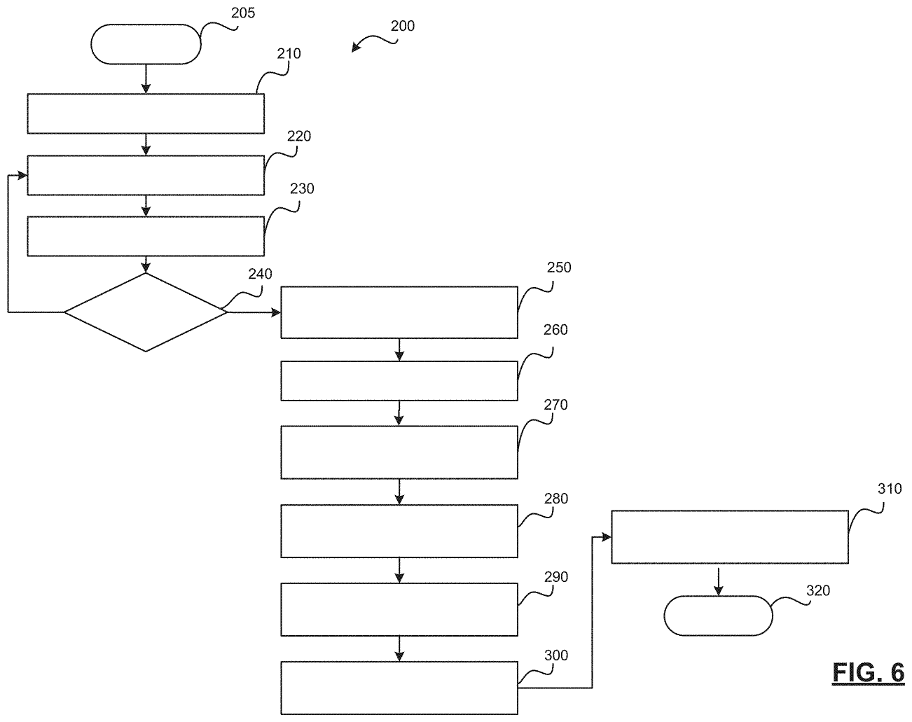

Referring now to FIGS. 5 and 6, and with continued reference to FIGS. 1-4 flowcharts illustrate methods 100, 200 that can be performed by the virtual reality system 12 in accordance with various embodiments. As can be appreciated in light of the disclosure, the order of operation within the methods 100, 200 is not limited to the sequential execution as illustrated in FIGS. 5 and 6 but may be performed in one or more varying orders as applicable and in accordance with the present disclosure.

As can further be appreciated, the methods 100, 200 of FIGS. 5 and 6 may be scheduled to run at predetermined time intervals during operation of the vehicle 10 and/or may be scheduled to run based on predetermined events.

As shown in FIG. 5, the method 100 determines and stores the shape data for correcting stitched scenes. In various embodiments, the method 100 may be performed by the control module 34 of FIGS. 1 and 2 and, more particularly, by the shape determination module 50 of FIG. 4. In one example, the method may begin at 105. The camera input data is received at 110 and a frame is extracted at 120. The frame is evaluated for features such as lines or other key points at 130. Coordinates of the features are transformed to a vehicle coordinate system at 140. A confidence score and weights of the feature coordinates are computed based on model prediction at 150. A final transformation of the coordinates is computed based on the confidence score at 160. Thereafter, the final coordinates are stored as shape data in the features datastore at 170; and the method may end at 180.

As shown in FIG. 6, the method 200 corrects errors in stitching using the shape data. In various embodiments, the method 200 may be performed by the control module 34 of FIGS. 1 and 2 and, more particularly, by the stitching module 52 of FIG. 4. In one example, the method may begin at 205. The camera input data is received at 210 and a frame is extracted at 220.

A top-down projection and stitching of the frame is performed at 230. The projected frame is checked for errors at 240. When an error is not found at 240, the method 200 continues with obtaining the next frame from the sensor data at 220.

When an error is found at 240, a shape associated with the error is matched with a shape stored in the features datastore at 250. Coordinate transformation is performed on the frame based on vehicle odometry at 260. Any shadows present in the frame are removed at 270. The coordinates of the frame corresponding to the error are transformed based on the matched shape data at 280. Any lines associated with the shape are smoothed at 290 and inner edges of any contours are sharpened at 300. Thereafter, the final improved scene data is provided for display by the display device at 310; and the method may end at 320.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A system to aid an operator in operating a vehicle, comprising:
a sensor system configured to generate sensor data sensed from an environment of the vehicle; and
a control module configured to, by a processor, determine a scene of the environment based on the sensor data, identify coordinates of at least one feature within the scene, compute a confidence score of the coordinates based on at least one of vehicle speed data, steering angle data, and real-world geometry data, memorize the coordinates as feature coordinates of the at least one feature in the scene, modify video data by warping a ground plane of one or more parts of stitched scene data based on the memorized feature coordinates, and present the modified video data for display to the operator.

2. The system of claim 1, wherein the sensor system includes one or more cameras.

3. The system of claim 1, wherein the at least one feature includes a printed marking on the ground.

4. The system of claim 1, wherein the control module is further configured to, by the processor, stitch the sensor data to form the scene of the environment, and identify an error in a feature of the stitched sensor data, and wherein the video data is modified based on the identified error.

5. The system of claim 4, wherein the control module is further configured to match the feature having the error to the memorized feature coordinates.

6. (canceled)

7. The system of claim 1, wherein the control module is configured to modify the video data by smoothing lines in the warped ground plane.

8. The system of claim 7, wherein the control module is further configured to modify the video data by sharpening an edge of the smoothed lines in the warped ground plane.

9. The system of claim 1, wherein the control module is further configured to stitch the sensor data and the memorized feature coordinates to modify the video data.

10. (canceled)

11. A method for aiding an operator in operating a vehicle, comprising:
receiving sensor data from a sensor system that senses an environment of the vehicle;
determining, by a processor, a scene of the environment based on the sensor data;
identifying, by a processor, coordinates of at least one feature within the scene,
computing, by a processor, a confidence score of the coordinates based on at least one of vehicle speed data, steering angle data, and real-world geometry data;
memorize the coordinates as feature coordinates of the at least one feature in the scene,
modifying, by the processor, video data by warping a ground plane of one or more parts of stitched scene data based on the memorized feature coordinates of the feature in the environment; and
generating display data to display the modified video data for viewing by the operator of the vehicle.

12. The method of claim 11, wherein the sensor system includes one or more cameras.

13. The method of claim 11, wherein the at least one feature includes a marking on a ground plane.

14. The method of claim 11, wherein the method further includes stitching the sensor data to form the scene of the environment and identifying an error in a feature of the stitched sensor data, and wherein the video data is modified based on the identified error.

15. The method of claim 14, wherein the method further includes matching the feature having the error to the memorized feature coordinates.

16. (canceled)

17. The method of claim 11 wherein the method further includes modifying the video data by smoothing lines in the warped ground plane.

18. The method of claim 17, wherein the method further includes modifying the video data by sharpening an edge of the smoothed lines in the warped ground plane.

19. The method of claim 17, further comprising stitching the sensor data and the memorized feature coordinates to modify the video data.

20. (canceled)
